(19) United States
(12) Patent Application Publication
(10) Pub. No.: US 2025/0390711 A1
(43) Pub. Date: Dec. 25, 2025

(54) AUTOMATIC RULE INDUCTION USING GENERATIVE AI

(71) Applicant: Palo Alto Networks, Inc., Santa Clara, CA (US)

(72) Inventors: Chandra Biksheswaran Mouleeswaran, Cupertino, CA (US); Sathya Prakash Rajagopal, San Jose, CA (US); Gaspar Modelo-Howard, Fremont, CA (US); Alok Tongaonkar, San Jose, CA (US)

(21) Appl. No.: 18/750,939

(22) Filed: Jun. 21, 2024

(51) Int. Cl. G06N 3/0455

(52) U.S. Cl. CPC G06N 3/0455

(57) ABSTRACT

A textual description of a rule/query is input to the disclosed system and a name of an application programming interface (API) is selected based on the textual description. With the API name, other parameters to guide rule induction are determined-a data model relevant to the API name and a pair of corresponding query examples in in a reference programming language and in a target programming language also relevant to the API name. A prompt is then built based on a template, the textual description, the API name, and the additional parameters. The API name and additional parameters can be considered context for task instructions in the prompt. The system submits the prompt to a foundation model to acquire a query in in the target programming language.

### BACKGROUND

The disclosure generally relates to use of generative artificial intelligence (e.g., CPC G06N) and generation of a cybersecurity rule related query (e.g., CPC H04L).

Rule learning systems use symbolic machine learning approaches for rule induction. Generally, rule induction involves learning or deducing IF-THEN rules from a dataset. The condition within the rule is based on an attribute-value pair or attribute value range, depending upon the attribute. The rule also indicates a consequent, which is a classification of an input determined from applying the rule to the rule input. Many inductive learning algorithms have been proposed for rule induction, one of the earliest being the Iterative Dichotomiser (“ID3”) which based on decision trees. More recent decision tree based algorithms are C4.5 and C5.0, which improved upon ID3. Another rule induction technique is association rules mining, implementations of which typically use the Apriori algorithm or FP-growth algorithm.

The National Institute of Standards and Technology defines a policy as “A rule or set of rules that govern the acceptable use of an organization's information and services to a level of acceptable risk and the means for protecting the organization's information assets” and provides an extended definition of “A rule or set of rules applied to an information system to provide security services.” An implementation of a cybersecurity policy consists of one or more rules, each consisting of a cybersecurity-related query. A cybersecurity-related query is query to determine whether a condition of a resource related to cybersecurity is satisfied. Typically, a query will identify an asset(s) or resource(s) that satisfies a condition(s) indicating a risk or potential risk.

### BRIEF DESCRIPTION OF THE DRAWINGS

Embodiments of the disclosure may be better understood by referencing the accompanying drawings.

FIG. 1 is a diagram of a system for automatic rule induction using generative AI.

FIG. 2 is a flowchart of example operations for acquiring a cybersecurity rule-related query from a generative AI model.

FIG. 3 is a flowchart of example operations for building a rule induction prompt based on a prompt template and retrieved values for rule induction parameters.

FIG. 4 is a flowchart of example operations for policy relevant resource data model induction.

FIG. 5 is a flowchart of example operations for updating rule induction parameter data based on feedback about the acquired query.

FIG. 6 depicts an example computer system with a generative AI-based rule induction system.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### Terminology

Industry literature often uses the terms “rule” and “query” as synonyms when referring to rules authored for a cybersecurity policy, which can include one or more rules. The consequent of a cybersecurity rule can be a security related action or a classification of something being evaluated as malicious, suspicious, etc. A cybersecurity rule related query will be a query to obtain values or data to evaluate a condition of a cybersecurity rule. While this disclosure can be used to create a policy or cybersecurity rule including a consequent, the description focuses on the acquisition of a query since the query is the core of a rule used to determine whether a rule “fires”. As the query is the core of a rule, the “rule induction” and “rule acquisition” encompass acquiring or obtaining a query. Initially, the description will refer to rule/query but progress to only referring to a query for efficiency.

This description uses the terms “foundation model” and “generative artificial intelligence (AI) model” interchangeably because the technology is relatively young and use of terms in industry is dynamic. Some articles would classify a generative AI model as one type of foundation model, but other articles refer to foundation generative AI models. Since this disclosure can use a model regardless of it being identified as a foundation model or a generative AI model, the description uses both terms.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

### Overview

While organizations adopt foundation models to automate and/or increase efficiency of certain tasks, the foundation models are not a panacea. For instance, a resource query language (RQL) has become useful to implement cybersecurity policies. However, few of these policies are publicly available. Thus, very few cybersecurity policies in RQL have been available for foundation models to learn to generate cybersecurity policies or rules or to induce policies/rules.

A system has been developed to use generative artificial intelligence (AI) or a foundation model to deduce cybersecurity rules/queries in a programming language or query language that is not well-known (“target language”) to the model based partly on leveraging the capabilities of the model with a well-known programming/query language (“reference programming language or reference language”). A textual description of a rule/query is input to the system, and a name of an application programming interface (API) is selected based on the textual description. The API name is selected from multiple API names used by an organization. With the API name, other parameters to guide rule induction are determined-a data model relevant to the API name and a pair of corresponding query examples in the different programming/query languages also relevant to the API name. A prompt is then built based on a template, the textual description, the API name, and the additional parameters. The API name and additional parameters can be considered context for task instructions in the prompt. The system submits the prompt to a foundation model to acquire a query in the target programming language.

### Example Illustrations

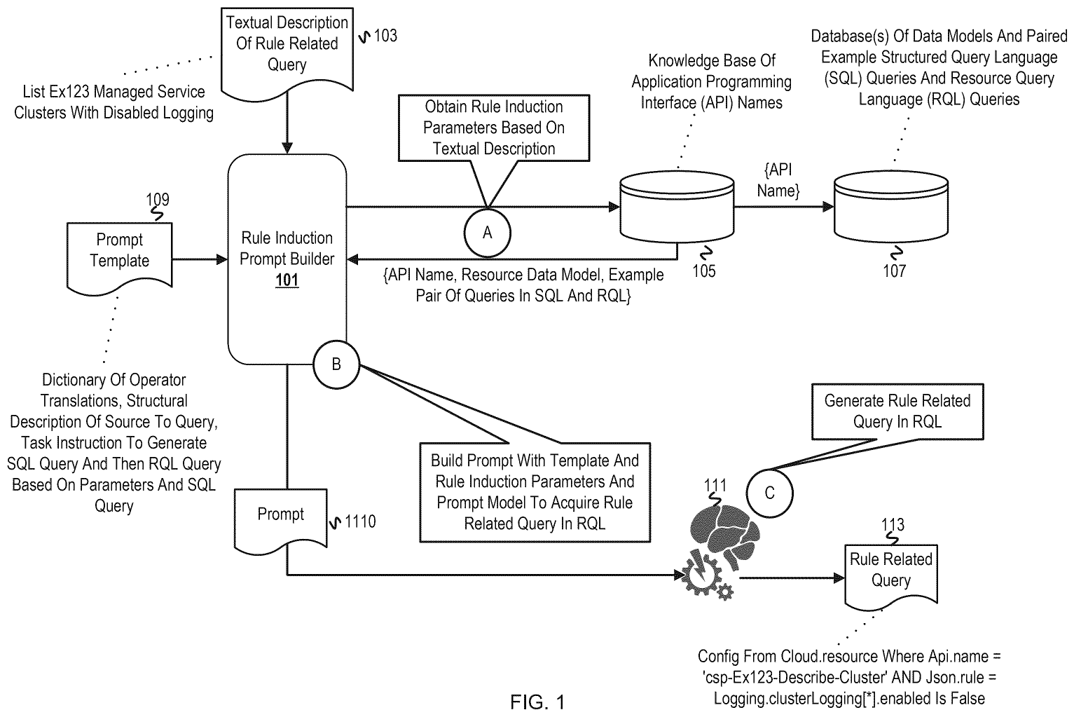

FIG. 1 is a diagram of a system for automatic rule induction using generative AI. The system includes a rule induction prompt builder 101, a knowledge base of API names 105, and a database 107 of rule induction parameters. The rule induction prompt builder 101 includes or has access to a prompt template 109. The prompt template 109 includes a task instruction for a model to write a security rule or rule-related query in a well-known programming language and a task instruction to translate or convert the rule/query into the target programming language. The prompt template 109 also includes fields or placeholders for the rule induction parameters, including an API name. The illustration refers to SQL as the well-known language and RQL as the target language (i.e., the language not well known generally to foundation models because of limited availability of examples for training). FIG. 1 depicts the system interacting with a generative AI model 111.

FIG. 1 is annotated with a series of letters A-C indicating stages, each of which represents one or more operations. Although these stages are ordered for this example, the stages illustrate one example to aid in understanding this disclosure and should not be used to limit the claims. Subject matter falling within the scope of the claims can vary from what is illustrated.

At stage A, the rule induction prompt builder 101 obtains rule induction parameters based on a textual description 103 of a rule or rule-related query. The rule induction prompt builder 101 may receive the textual description 103 from a user interface, read it from a file, receive it from another process, etc. The textual description 103 is a natural language description of a rule or query that may have been authored by a human or generated by generative AI. In FIG. 1, the textual description 103 is:
List ex 123 managed service clusters with disabled logging.

The rule induction prompt builder 101 accesses the knowledge base 105 of API names based on the textual description to determine one of the API names most relevant to the textual description. A relevant API name can be determined with retrieval augmented generation or a similar technique that accesses database/repository of relevant information, such as a vector or embeddings database. With the most relevant API name, the system accesses the database 107 to gather additional rule induction parameters relevant to the API name. The additional parameters include a data model and paired example queries of the different languages. The database 107 hosts data models and the paired example queries. Each data model indicates the attributes and attribute data types for each resource of each API name determined from existing cybersecurity policies of an organization. The paired example queries are example queries in SQL paired with corresponding example queries in RQL. These paired example queries are used as examples to a generative AI model, or for few-shot prompt learning.

At stage B, the rule induction prompt builder 101 builds a prompt 110 to acquire a rule/query from a generative AI model. The rule induction prompt builder 101 retrieves the prompt template 109. The prompt template 109 includes a dictionary of translations between SQL operators and RQL operators. The prompt template 109 also includes a structural description (e.g., schema) of a source to be queried with the query to be created. The prompt template 109 includes a task instruction for a model to create a rule-related query in SQL and to then translate the SQL query into RQL with the rule induction parameters being added to provide context.

At stage C, the generative AI model 111 outputs or generates a rule-related query 113 in RQL based on the prompt 110. FIG. 1 illustrates the generated rule-related query 113 as:
config from cloud.resource where api.name=‘csp-Ex123-describe-cluster’ AND json.rule=logging.clusterLogging [*].enabled is false
The rule-related query 113 can be validated and incorporated into a cybersecurity policy, for instance a cloud security posture management (CSPM) policy.

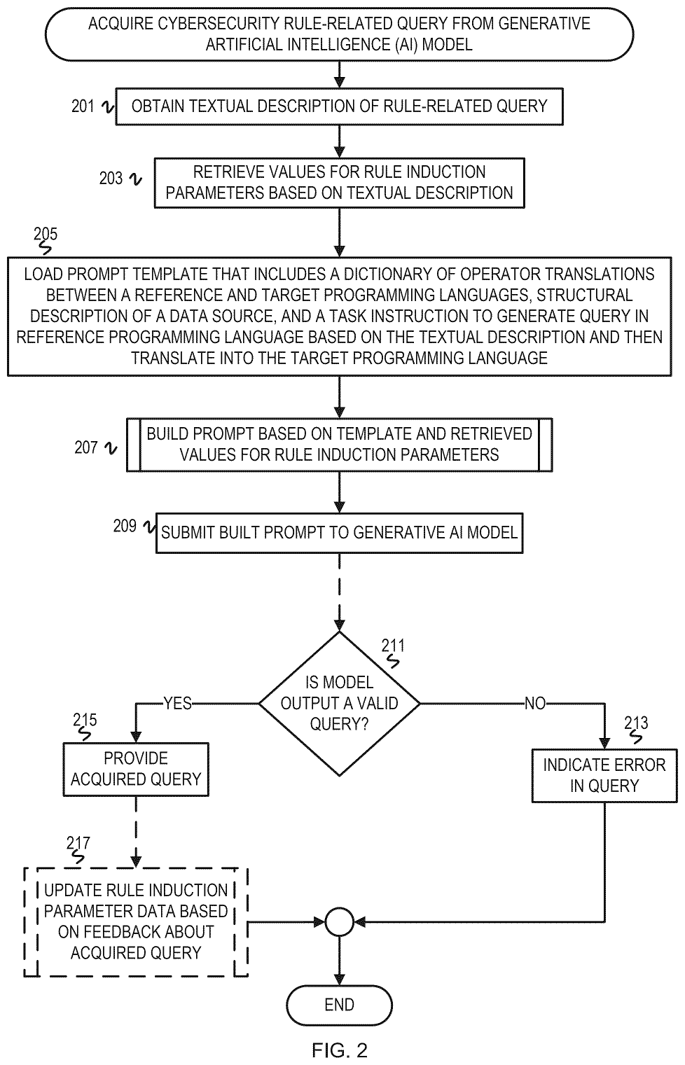

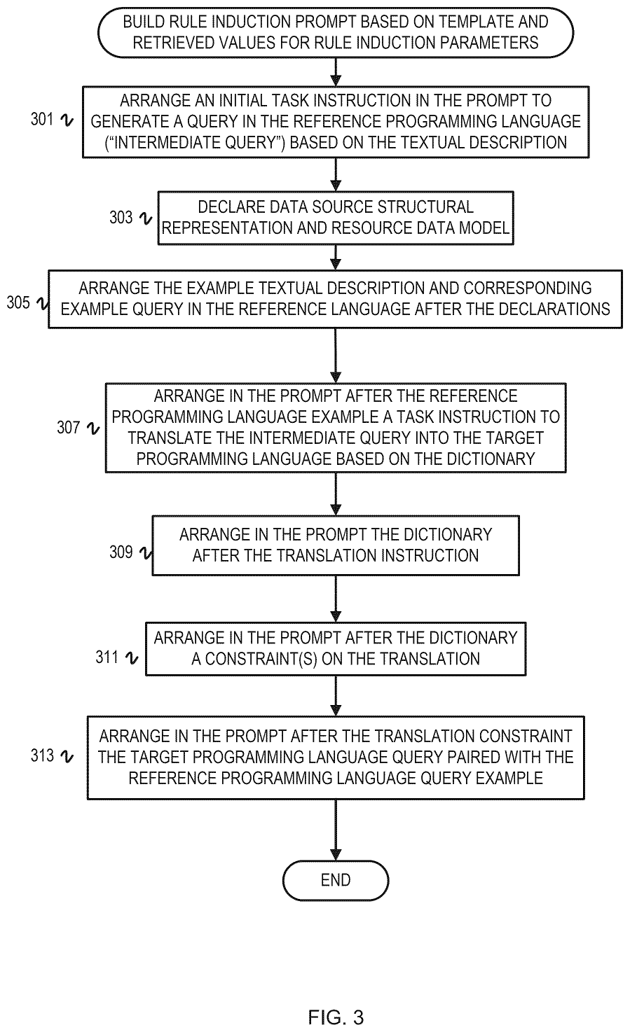

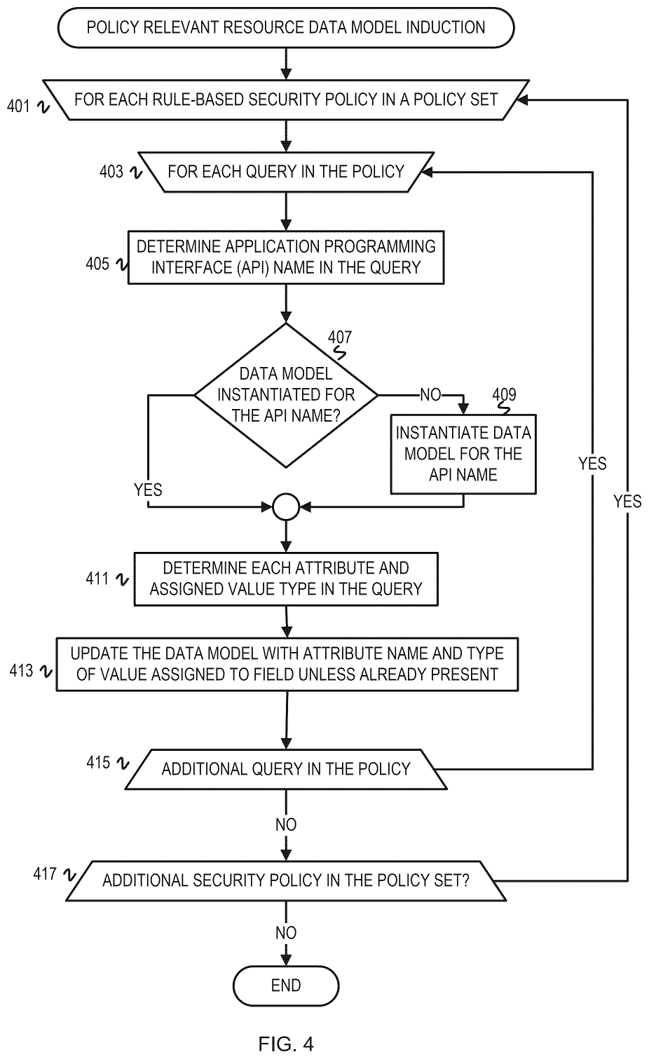

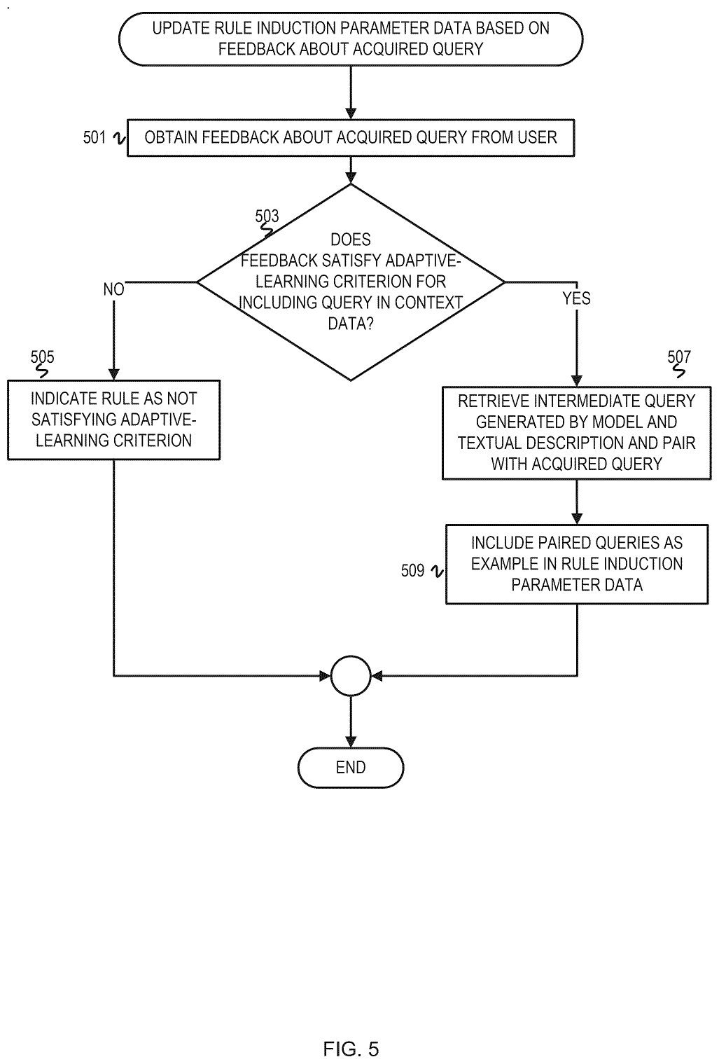

FIGS. 2-5 are flowcharts that relate to rule induction using generative AI. FIGS. 2-3 are flowcharts of example operations that relate directly to rule induction using generative AI. FIGS. 4-5 relate to rule induction using generative AI, but less directly. FIGS. 2-3 are described with reference to a prompt builder as a more succinct reference to the rule induction prompt builder. FIGS. 4 and 5 are described with reference to a generative AI based rule induction system as the flowcharts encompass more than the prompt builder. The example operations are described with reference to the prompt builder and the generative AI based rule induction system for consistency with FIG. 1 and ease of understanding. The name chosen for the program code is not to be limiting on the claims. Structure and organization of a program can vary due to platform, programmer/architect preferences, programming language, etc. In addition, names of code units (programs, modules, methods, functions, etc.) can vary for the same reasons and can be arbitrary.

FIG. 2 is a flowchart of example operations for acquiring a cybersecurity rule-related query from a generative AI model. Acquisition of the query is driven by the prompt that is built. The rule induction parameters and task instructions to generate the query in the reference programming language and then translate the reference programming language query into the target programming language facilitate the high-quality of queries that can be generated from a generative AI model.

At block 201, a prompt builder obtains a textual description of a rule-related query. The textual description may be input into a user interface that passes the textual description to the prompt builder. The textual description may be read from a file or database. In some cases, generative AI, such as a large language model (LLM), can be used to generate descriptions of existing cybersecurity rule-related queries in a reference language, which are then fed to the prompt builder.

At block 203, the prompt builder retrieves values for rule induction parameters based on the textual description. This is a multi-step retrieval that begins with determining a name of an API relevant to the textual description and then obtaining other parameters based on the determined API name. For example, the prompt builder generates an embedding(s) from the textual description and then accesses an embeddings database populated with embeddings of API names to determine which API name embedding is most similar and/or relevant to the embedding(s) of the textual description. Embodiments can generate a single embedding from the textual description for accessing the embeddings database. Other embodiments can expand the sample set for the textual description by generating multiple variants of the textual description and generating embeddings for the variants. This increases coverage of semantic manifestations that may be seen at runtime. The embeddings database is populated with embeddings of API names detected in rule-related queries of an organization. Embodiments are not limited to using an embeddings database. Embodiments can instead maintain a database of API names and search the database of API names based on named entity extraction or keyword extraction from the textual description. With the API name, the prompt builder retrieves the other rule induction parameters. For instance, an organization can maintain a database of resource data models and a database of paired query examples. Creation of a resource data model will be discussed with reference to FIG. 4. The database of paired query examples is a database with each entry being a pairing of example rule-related queries: a rule-related query in a reference programming language and a corresponding or counterpart query in the target programming language. In addition to the pairing of queries, the query in the reference programming language is associated with an example textual description so that the reference language example query provides an example of generating a query from a textual description to the generative AI model. The pairings can be determined by those with domain knowledge, such as cybersecurity experts. Embodiments can also employ a language model with inverted prompts to expand from manually created pairings or mappings between reference and target programming language queries. Manually created mappings can be used as seed samples. For instance, assume seed samples include mappings created from n policies for each of x API names. With the seed samples as examples in few shot prompts, inverted prompts that provide target programming language queries to the language model are used to generate the reference language queries for pairing/mapping.

At block 205, the prompt builder loads or reads a prompt template from a configuration file or memory location, for example. The prompt template includes a dictionary of operator translations, a data source structural description, and task instructions. The dictionary includes translations between operators of a reference programming language and operators of the target programming language. The structural description of a data source provides the basic schema of a data source that will be common across queries-particularly the intermediate and target queries, which will be explained in more detail with reference to the task instructions. For example, the structural description can be the below table schema.

<table_schema>
<api.name/>String</api.name>
<cloud.type>String</cloud.type>
<cloud.account>String</cloud.account>
<resource.status>String</resource.status>
</table_schema>

The task instructions include a first task instruction to generate a query in the reference programming language based on the textual description. This query is referred to as the intermediate query in this description. The task instructions also include a second task instruction to translate the intermediate query into the target programming language, which yields the target query. The second task instruction or translation instruction will also specify the use of the dictionary for the translation and constraints of the target programming language, such as logically combining multiple conditions into a single rule-related query. The prompt template may also include other context or task instructions to improve quality of the response from a generative AI model. For instance, the prompt template can include assignment of a role (e.g., “You are a cybersecurity expert who authors query based cybersecurity rules for cloud assets”) and a task instruction to explain the output (e.g., “If you combine conditions into a rule-based query, explain the reasons for combining conditions and explain the reason for the translation.”).

At block 207, the prompt builder builds a prompt based on the template, textual description, and retrieved values for rule induction parameters. To build the prompt, the prompt builder arranges elements from the template and the rule induction parameters values. Building of the prompt is discussed in more detail with reference to FIG. 3.

At block 209, the prompt builder submits the built prompt to a generative AI model. This can vary depending upon deployment of the generative AI model being used. For instance, the prompt builder can submit the prompt with an API call for a locally deployed model or a web API call for a remotely deployed model.

Upon receipt of a response from the generative AI model (represented by the dashed line from block 209 to block 211), the prompt builder determines whether the generative AI model output a valid query. Below is an example of a generative AI model output query and the corresponding initial textual description.

Textual description: List ks clusters open to the internet or not configured for private access

Model generated query in RQL: config from cloud.resource where
cloud.type = ‘csp’
AND api.name = ‘csp-eks-describe-cluster’ AND json.rule =
resourcesVpcConfig.endpointPublicAccess is true OR
resourcesVpcConfig.endpointPrivateAccess is false

The prompt builder can invoke a function that checks syntax of the query for the target programming language. If the output is not a valid query for the target programming language, then operational flow proceeds to block 213. Otherwise, operational flow proceeds to block 215.

At block 213, the prompt builder indicates a syntax error(s) in the query. Implementations can vary as to treatment of an erroneous output from the generative AI model. As examples, the output with the identified error(s) can be presented to a user for review; the output can be preserved for later analysis to gain intelligence for evaluating the prompt and/or generative AI model capabilities; and the output can be discarded and a notification returned in association with the textual description that a satisfactory query could not be acquired.

At block 215, the prompt builder provides the acquired query. An implementation can present the query in a user interface, write the query to a file, run the query and provide the results in association with the query that was run. To illustrate, the textual description may have been input via a user interface. The generated query in the target programming language is presented in the user interface in relation to the textual description. The user can then select to run the query.

At block 217, the prompt builder, as part of a generative AI-based rule induction system, updates rule induction parameter data based on feedback about the acquired query. Depiction of block 217 in a dashed line indicates the operation(s) as optional. FIG. 4 presents example operations for this feedback aspect.

FIG. 3 is a flowchart of example operations for building a rule induction prompt based on a prompt template and retrieved values for rule induction parameters. The operations of FIG. 3 presume that the template and rule induction parameters values have already been retrieved. The operations refer to arranging these elements for building the prompt. The term “arranging” or “arranged” is used to be untethered to a specific implementation broadly encompass the different implementations (e.g., copy template elements and parameter values into a blank prompt data structure, copy the template and populate placeholders in the template with the values of the rule induction parameters, etc.).

At block 301, the prompt builder arranges an initial task instruction in the prompt to generate a query in the reference programming language (“intermediate query”) based on the textual description. For instance, the prompt template includes an initial instruction “Given a description, convert the description into a SQL query. <description>.” The prompt builder replaces the placeholder with the obtained textual description. “The initial task instruction may also specify a syntax of the specified reference programming language for compliance by the generative AI model.

At block 303, the prompt builder declares the data source structural representation and the resource data model. This information provides the generative AI model context for the generation of an intermediate query and the target query. To illustrate, assume the textual description that was obtained is “List containerizedX clusters open to the internet or not configured for private access.” Based on this textual description, the API name retrieved is “csp123-eks-describe-cluster.” A Javascript® Object Notation (JSON) example of the retrieved resource data model relevant to the retrieved API name is below.

<JSON_Model-csp123-eks-describe-cluster> {
“resourcesVpcConfig.endpointPublicAccess”: true,
“tags[ ].key”: “String”,
“tags[ ].value”: “String”,
“resourcesVpcConfig.endpointPrivateAccess”: true,
“version”: “String”,
“logging.clusterLogging[ ].types[ ]”: “String”,
“createdAt”: “String”,
“endpoint”: “String”,
“resourcesVpcConfig.vpcId”: “String”,
“roleArn”: “String”,
“platformVersion”: “String”,
“name”: “String”,
“resourcesVpcConfig.securityGroupIds[ ]”: “String”,
“arn”: “String”,
“certificateAuthority.data”: “String”,
“resourcesVpcConfig.subnetIds[ ]”: “String”,
“logging.clusterLogging[ ].enabled”: true,
“status”: “String”
}
</JSON_Model-csp123-eks-describe-cluster>

At block 305, the prompt builder arranges the example textual description and corresponding example query in the reference language after the declarations. The retrieved pairing of example queries includes a corresponding example textual description that was a basis for the example query in the reference programming language. The prompt builder arranges that example description and example reference language query after the declarations.

At block 307, the prompt builder arranges in the prompt after the reference programming language example a task instruction to translate the intermediate query into the target programming language based on the dictionary. For instance, the prompt template can include the translation task instruction “After converting the description into a SQL query, translate your SQL query into RQL. Conform the translation to the translation rules indicated in the dictionary. Here is the dictionary.”

At block 309, the prompt builder arranges in the prompt the dictionary after the translation instruction. The prompt template can include markers or indicators identifying the dictionary as the translation rules relevant to the translation instruction.

At block 311, the prompt builder arranges in the prompt after the dictionary a constraint(s) on the translation. Using a JSON based example, the prompt template can include the constraint, “The generated query should only include 1 json rule. Use the logical operators AND, OR, NOT to combine multiple conditions and insert the combined conditions into the json rule.”

At block 313, the prompt builder arranges in the prompt after the translation constraint the retrieved target programming language query example that was paired with the reference programming language query example. The prompt template can include the statement, “Here is an example of a RQL query that corresponds to the preceding example of a SQL query generated from the example description. <RQL Example>.” The prompt builder can replace the placeholder with the retrieved reference programming language query example.

As previously mentioned, the disclosed system also creates precise resource data models relevant to an organization. These resource data models provide guidance to the generative AI model.

FIG. 4 is a flowchart of example operations for policy relevant resource data model induction. These example operations create a data model for a resource corresponding to a named API. To reduce noise and efficiently yield precise information relevant to an organization, resource data models are built based on the rulebase (i.e., collection of rules in cybersecurity policies) of an organization.

At block 401, a generative AI-based rule induction system begins processing each rule-based cybersecurity policy in a policy set of an organization. The system is searching through the policy set to identify which APIs are used and which attribute-value pairs are indicated. Since the system is searching a set of cybersecurity policies, the operating assumption is that the indicated APIs and attributes are security related. Resource identifiers are treated as attributes for efficiency. Instead of creating a separate data model for each resource of each API, the identifier of a resource is treated as an attribute since multiple APIs may access the same resource.

At block 403, the generative AI-based rule induction system begins processing each query in the policy. As stated earlier, a policy can comprise multiple rule-based queries.

At block 405, the generative AI-based rule induction system determines an API name in the query. This can be determined based on the semantics of the query. For example, the query may include the keyword “api-name.”

At block 407, the generative AI-based rule induction system determines whether a data model has been instantiated for the API name. The system will create the data model while it examines the rules of the policies in the policy set. Thus, multiple data models may be under construction in parallel. If a data model is already under construction, then operational flow proceeds to block 411. If a data model for the named API is not yet under construction, then operational flow proceeds to block 409.

At block 409, the generative AI-based rule induction system instantiates a data model for the API name. For instance, an object or entry is initialized in a database or repository of data models. The data model is initialized with the API name for accessing/indexing. Operational flow proceeds from block 409 to block 411.

At block 411, the generative AI-based rule induction system determines each attribute and assigned value type in the query. Again, semantics or known structure of the query guides determination of attribute-value pairs. For example, a query syntax may be that attribute-value pairs are related by “: =”. The system determines whether the value is a string, Boolean, or integer.

At block 413, the generative AI-based rule induction system updates the data model with attribute name and type of value assigned to attribute, unless already present. After determining the attribute name, the system will determine whether the attribute name is already indicated in the data model. If so, there is no reason to update. However, implementations can use multiple instances of an attribute to verify a data type for an attribute.

At block 415, the generative AI-based rule induction system determines whether there is an additional query in the policy to process. If there is an additional query, then operational flow returns to block 403. If not, then operational flow proceeds to block 417.

At block 417, the generative AI-based rule induction system determines whether there is an additional policy in the policy set to process. If there is an additional policy, then operational flow returns to block 401. If not, then the operations of FIG. 4 end.

The generative AI-based rule induction system can periodically review the rule induction parameter data to update it. The system can periodically review a policy set to update API names and data models. Cybersecurity personnel can review the example queries to edit or add examples. In addition, the generative AI-based rule induction system can incorporate feedback about acquired queries to adaptively learn examples.

FIG. 5 is a flowchart of example operations for updating rule induction parameter data based on feedback about the acquired query. Updating the rule induction parameter data based on feedback about rules acquired from a generative AI model allows the rule induction system to adapt learning based on the feedback because the feedback will be incorporated into the prompts to the generative AI model.

At block 501, the generative AI-based rule induction system obtains feedback about an acquired query from a user. After providing the acquired query, the prompt builder can obtain feedback about the query from a user. The prompt builder can request that a user interface present selectable options and/or text-based feedback. The options can be whether the query is used or rejected. The feedback can be a user-edited version of the acquired query.

At block 503, the generative AI-based rule induction system determines whether the feedback satisfies an adaptive-learning criterion. The adaptive-learning criterion is a criterion specified for whether or not an acquired rule can be incorporated into the rule induction parameter data, specifically the query examples. The criterion can be that the user accepted or used the acquired query. If the feedback is a textual feedback (i.e., unstructured feedback), then the system can apply natural language processing or ask a generative AI model whether the feedback indicates that the acquired rule was used without modification. If the criterion is not satisfied, then operational flow proceeds to block 505. Otherwise, operational flow proceeds to block 507.

At block 505, the generative AI-based rule induction system indicates the acquired query as not satisfying the adaptive-learning criterion. The system may discard the query or store it for analysis to determine why it was unacceptable. Operational flow ends from block 505.

At block 507, the generative AI-based rule induction system retrieves the intermediate query generated by the generative AI model and textual description corresponding to the acquired query. The prompt template can include a task instruction to include the intermediate query in the response. This can be part of the prompt template or in an alternative prompt template used when feedback is being collected. The prompt builder can then maintain the textual description and the intermediate query in association until feedback is collected. If the acquired query satisfies the adaptive learning criterion, then the system pairs the intermediate query with the acquired query, along with the textual description.

At block 509, the generative AI-based rule induction system includes the paired queries as an example in the rule induction parameter data. For instance, the system inserts an object or entry in the database of examples. The entry/object is indexed by the corresponding API name and includes a tuple of the text, intermediate query, and acquired query. Metadata indicating the programming languages can also be associated with the entry/object.

### Variations

The disclosure provides examples that should not be used to limit the claims. For instance, an example for building a rule induction prompt is given but implementations can vary. As mentioned, a prompt template can include additional task instructions and/or context, such as role assignment and/or a task instruction to explain the response, to increase quality of the model response. An embodiment may use chained prompts instead of a single prompt. For instance, a first prompt will prompt a generative AI model to generate the intermediate query and a second prompt will include context and the intermediate query along with the task instruction to generate the target query or translate the intermediate query into the target programming language. Referring again to the example in FIG. 3, the arrangement of elements to form or build the prompt can vary. As one example, the target programming language query example can be arranged subsequent to its paired reference programming language query example. As another example of a different arrangement of elements, the translation constraint can be part of the translation instruction or adjacent to the translation instruction. Also, the disclosure referred to purposely constraining the values of rule induction parameters to those indicated in the existing policy set of an organization. However, embodiments can selectively add API names and attributes outside of those indicating in an organization's policy set to reflect, for example, newly added APIs, resources, or attributes by a cloud service provider.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For example, the operations depicted in process the policy set differently. The system can select from the policy set based on named APIs. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

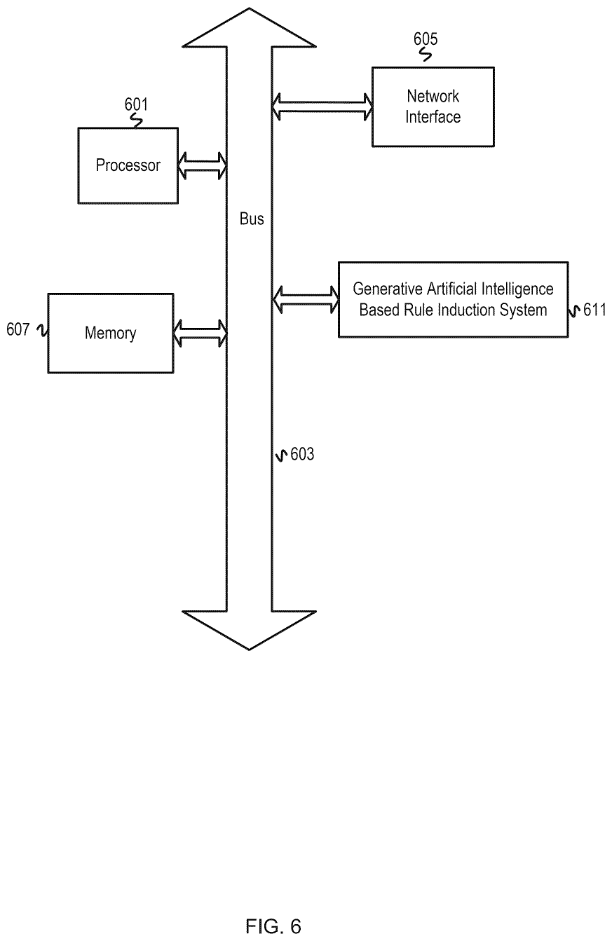

FIG. 6 depicts an example computer system with a generative AI-based rule induction system. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a generative AI-based rule induction system 611. The generative AI-based rule induction system 611 includes components to store and access rule induction parameter data used to provide context in a prompt to a generative AI model and to build a prompt for a generative AI model to generate a cybersecurity rule related query in a target programming language. The generative AI-based rule induction system 611 obtains a textual or natural language description of a rule or query for a cybersecurity policy for an organization. The generative AI-based rule induction system 611 uses the description to determine a name of an API known to be used by the organization. The generative AI-based rule induction system 611 retrieves additional context for the generative AI model, which are additional parameter values corresponding to the API name. The generative AI-based rule induction system 611 builds a prompt with a prompt template and the retrieved context/parameter values and submits the prompt to the generative AI model to obtain a query in the target programming language. Any one of the previously described functionalities may be partially (or entirely) implemented in hardware and/or on the processor 601. For example, the functionality may be implemented with an application specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
obtaining a textual description of a query;
generating a first query in a target programming language based on the textual description, wherein generating the first query comprises,
based on the textual description, retrieving an application programming interface (API) name;
retrieving a data model corresponding to the API name, a first example query in a first programming language corresponding to the API name, and a second example query in the target programming language corresponding to the first example query;
building a prompt with a prompt template, the textual description, the API name, the data model, and the first and second example queries, wherein the prompt template comprises a dictionary of operator translations between the first programming language and the target programming language, a first task instruction to generate a second query in the first programming language based on the textual description, a second task instruction to translate the second query into the target programming language in accordance with constraints of the target programming language, with the dictionary, and with indication of a general structure of a repository; and
prompting a foundation model with the prompt.

2. The method of claim 1, wherein retrieving the API name comprises retrieving the API name according to retrieval augmented generation based on the textual description.

3. The method of claim 2, wherein retrieving the data model and the first and second example queries comprises accessing a database with the retrieved API name.

4. The method of claim 1 further comprising labelling the first query based on feedback about the first query and updating one or more knowledge bases used for the retrieval augmented generation based on the labelled first query.

5. The method of claim 1, wherein retrieving the API name comprises parsing the textual description for named entities and querying a database based on the named entities.

6. The method of claim 1, wherein the textual description is a textual description of a cybersecurity rule-based policy or a query related to a cybersecurity rule.

7. The method of claim 1, wherein the first programming language is a structured query language (SQL) and the target programming language is a resource query language (RQL).

8. The method of claim 1 further comprising generating a rule-based cybersecurity policy based on the textual description, wherein generating the rule-based cybersecurity policy comprises generating a set of one or more queries including the first query and wherein the textual description is of a rule-based cybersecurity policy.

9. A non-transitory, machine-readable medium having program code for automated cybersecurity rule induction stored thereon, the program code comprising instructions to:
obtain a textual description of a security rule related query;
retrieve context based on the textual description, wherein the instructions to retrieve context comprise the instructions to,
determine a name of an application programming interface (API) based on the textual description; and
retrieve a data model corresponding to the API name, a first example query in a first programming language based on the API name, and a second example query in a target programming language which corresponds to the first example query;
build an input sequence with a template, the textual description, and the context, wherein the template comprises a dictionary of operator translations between the first programming language and the target programming language, a first task instruction to generate a first query in the first programming language based on the textual description, a second task instruction to translate the first query into the target programming language based on the context and a structural description of a source to be queried; and
submit the input sequence to a language model.

10. The non-transitory machine-readable medium of claim 9, wherein the instructions to determine a name of an API based on the textual description comprise instructions to search one or more knowledge databases for a most similar of a plurality of API names with respect to the textual description.

11. The non-transitory machine-readable medium of claim 9, wherein the program code further comprises instructions to label the translation of the first query based on feedback about the translation of the first query and update a database that hosts the example queries based on the labelled first query translation.

12. The non-transitory machine-readable medium of claim 9, wherein the instructions to determine a name of an API based on the textual description comprise instructions to parse the textual description to identify named entities and to search one or more databases for the API name based on the name entities.

13. The non-transitory machine-readable medium of claim 9, wherein the second task instruction includes a constraint that the translation is according to syntax constraints of the target programming language.

14. The non-transitory machine-readable medium of claim 9, wherein the textual description is a textual description of a cybersecurity rule-based policy or a query related to a cybersecurity rule.

15. An apparatus comprising:
a processor; and
a machine-readable medium having instructions stored thereon that are executable by the processor to cause the apparatus to,
in response to input of a textual description of a cybersecurity rule or cybersecurity-related query, retrieve context for the textual description, wherein the context comprises an application programming interface (API) name, a data model corresponding to the API name, a first example query in a first programming language, and a second example query in a target programming language which corresponds to the first example query;
build an input sequence with a template, the textual description, and the context, wherein the template comprises a dictionary of operator translations between the first programming language and the target programming language, a first task instruction to generate a first query in the first programming language based on the textual description, a second task instruction to translate the first query into the target programming language based on the context and a structural description of a source to be queried;
submit the input sequence to a language model; and
present the translation of the first query.

16. The apparatus of claim 15, wherein the instructions to retrieve context based on a textual description comprise instructions executable by the processor to cause the apparatus to determine the API name relevant to the textual description based on one of retrieval augmented generation and a database search based on named entities identified in the textual description.

17. The apparatus of claim 15, wherein the machine-readable medium further comprises instructions executable by the processor to cause the apparatus to label the translation of the first query based on feedback about the translation of the first query and update a database that hosts example queries based on the labelled first query translation.

18. The apparatus of claim 15, wherein the instructions to retrieve context based on a textual description comprise instructions executable by the processor to cause the apparatus to search one or more databases for the data model and the example queries based on the API name.

19. The apparatus of claim 15, wherein the second task instruction includes a constraint that the translation is according to syntax constraints of the target programming language.

20. The apparatus of claim 15, wherein the textual description is a textual description of a cybersecurity rule-based policy or a query related to a cybersecurity rule.
